(19) United States
(12) Patent Application Publication
(10) Pub. No.: US 2009/0164971 A1
(43) Pub. Date: Jun. 25, 2009

(54) Convention Based UML Modeling Tool

(75) Inventors: Sandeep Kohli, Bangalore (IN); Sreerupa Sen, Bangalore (IN)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/960,297

(22) Filed: Dec. 19, 2007

(51) Int. Cl. G06F 9/44

(52) U.S. Cl. 717/105

(57) ABSTRACT

Within the exemplary embodiments a user is presented with a GUI comprising a main modeling interface window wherein a convention-based model is constructed. The GUI further comprises and an icon repository window wherein the basic modeling tools that are provided within the exemplary embodiments are displayed to the user. Using conventional input devices, a user can drag the representations of the icons that are displayed within the icon repository window into the main modeling interface window in order to construct a desired convention-based model.

### BACKGROUND OF THE INVENTION

1. Field of the Invention

This invention relates to unified modeling language (UML) modeling and particularly to a convention-based approach to UML modeling.

2. Description of Background

Many problems can arise when creating a UML system model. Current modeling tools may present problems to a user due to the complexity involved in graphically designing an abstract system representation. As such, a problem with general purpose modeling tools is that in the event that a modeling tool comprises a large collection of user interface (UI) elements for a user to select from when creating a model, the user may have difficulty in selecting the appropriate elements when constructing a particular model. If a user does not know the specific nuances of the elements that are necessitated to construct a model, then this presents an added difficulty in the constructing of a system model.

### SUMMARY OF THE INVENTION

The shortcomings of the prior art are overcome and additional advantages are provided through the provision of a method for creating a UML model. The method comprises displaying a GUI at a display device, wherein the GUI comprises a modeling interface window, the interface window further display an icon repository window, the icon repository window displaying an icon of a UML element and a UML connector comprising a first end and a second end, creating a model by dragging at least two UML element icons from the icon repository window into the modeling interface window, each UML element icon further comprising a sub-compartment, wherein the UML element icon has a square or rectangular shape, and defining the utility of the at least two UML element icons by labeling each icon with a UML element type classifier and an UML element identifier.

The method also comprises defining the relationship between the at least two UML element icons by dragging a connector from the icon repository window into the modeling interface window and placing the first and second end of the connector in visual contact with differing UML element icons, wherein the utility of the connector is identified by labeling the UML connector with a qualifying relationship classifier and a role classification label, defining at least one UML concept for a UML element icon by labeling the sub-compartment of a box with a UML concept classifier and a UML concept designator, extending the definitions of the definition of the utility of a UML element icon or a UML concept classifier by appending a predetermined convention-based concept designator to the UML icon or UML concept classifier label and generating a UML model based upon the model drawn within the modeling interface window.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of convention specific UML element icons in accordance with exemplary embodiments of the present invention.

FIG. 2 illustrates one example of connectors implemented in conjunction with UML element icons in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the exemplary embodiment of the present invention can be implemented within a conventional computing system environment comprising hardware and software elements. Specifically, the methodologies of the present invention can be implemented to program a conventional computer system in order to accomplish the prescribed tasks of the present invention as described below.

The exemplary embodiment as described herein is described as being used in conjunction with a UML modeling tool. However, it should be apparent to a person skilled in the art that the exemplary embodiments of the present invention can be utilized as a stand-alone modeling tool or as an extension to any conventional software modeling tool. In operation, the exemplary model serves to free a user from the complexities that are involved in using conventional modeling tools by providing the user with the capability to specify an element that the user desires to drawn on a UI surface by use of a convention (e.g., convention_string_representing_type:element_name:more_convention).

The character string “convention_string_representing_type” basically identifies the various elements the user wishes to utilize in constructing a model. It must be noted that the user can specify a mapping between the fore mentioned character string “convention_string_representing_type” and any available UI elements via a map that is provided at later stages within the constructing of a model or when the user specifies the use of a new convention string for the first time. For example, a first user may desire use to use a string “cls:” to denote a “class” kind of UI element, where as a secondary user using a different instance of the modeling tool provided within the exemplary embodiment may desire to use the string “class:” to denote a “class” kind of UI element. The map that can be created dynamically within the exemplary embodiment will specify that both conventions (i.e., cls: or class:) will map to a same UI element called class. Both instances of the models prepared by the first and secondary user can be exported into a conventional model, wherein the models can thereafter be read and modified within a target conventional modeling tool.

Thus in an effort to provide a simple solution to conventional modeling tools, the exemplary embodiment of the present invention provides a user with a graphical box representation (e.g., in the shape of a rectangle or square) and the capability to annotate the graphic box with desired representations of modeling conventions. Within the exemplary embodiments a graphic box representation can represent a plurality of desired UI elements. What a graphic box actually represents is decided by the convention the user follows and to what the feature is mapped to within a map. Further graphical representations of connectors are provided as simple straight line or arrow as a placeholders, wherein the representations of the connectors as decided by the convention that is followed can be annotated to the connector

Exemplary embodiments of the present invention provide a GUI modeling tool solution that can serve as a precursor modeling tool generator to any conventional UML modeling tool. In operation, a user is provided with streamlined modeling to in order to create simple diagrams (e.g., similar to diagrams that can be drawn upon a whiteboard or on paper). Thereafter, the created model can then be transformed into a UML model without losing the capability of having code generation and similar tools to generate code from the UML model that this is created by the present modeling tool.

Within the exemplary embodiments a user is presented with a GUI comprising a main modeling interface window wherein a convention-based model is constructed. The GUI further comprises and an icon repository window wherein the basic modeling tools that are provided within the exemplary embodiments are displayed to the user. Using conventional input devices, a user can drag the representations of the icons that are displayed within the icon repository window into the main modeling interface window in order to construct a desired convention-based model.

As previously mentioned, the exemplary embodiments of the present modeling tool provide the user with only a few basic shape elements. The basic elements are a UML element icon, and a connector icon. Within exemplary aspects of the present invention the UML element icon has either a square or rectangular shape. Each UML element icon, whatever the form, can also comprise a sub-compartment within the UML element icon. The connector icon is generally in the shape of a line segment, wherein the first end and second end of the line segment can further comprise arrows at the end pointing away from the respective line segment ending. Thus in operation, a user can draw a plurality of square box icons (or rectangular box icons) and line segments that visually show a connection, and thus the relationships, between the connected box icons. The user is also provided with a map via which the user can extend any necessitated software conventions (e.g., C++, Java™, etc.) for a system that the model is constructed to emulate that are provided outside of the box icon.

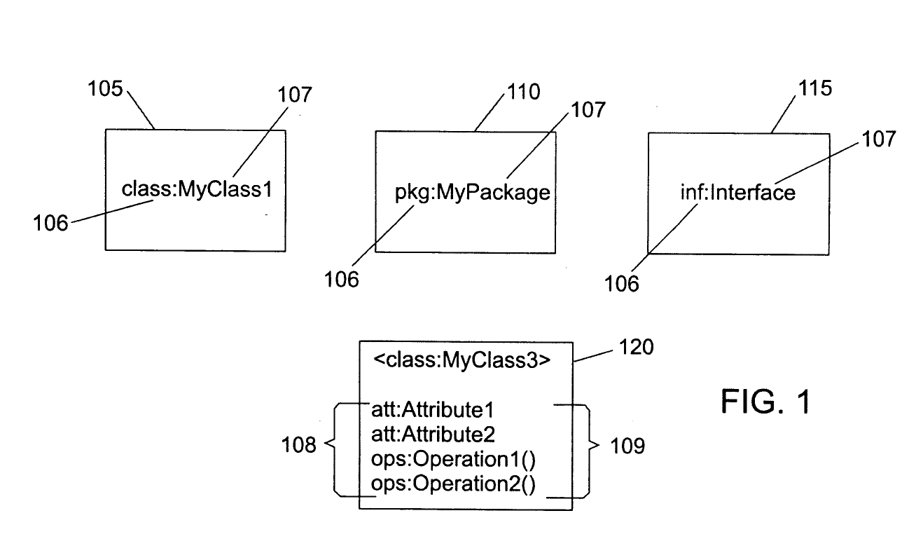

FIG. 1 shows examples of UML element icons (105, 110, 115, and 120) that may be created within exemplary embodiments. Each UML element icon (105, 110, 115, and 120) further comprises a UML element type classier 106 and an element identifier 107, wherein the UML element type classifier 106 and the element identifier 107 are utilized to further define the utility of a UML element icon (105, 110, 115, and 120). For example, the UML element type classifier 106 for UML element 105 is the word “class.” The element identifier 107 for UML element identifier 107 is the “MyClass1,” thus the element identifier 107 “MyClass1” is identified as a UML diagram class since it follows the UML element identifier 106 “class.”

Similarly, the UML element icon 110 is representative of a package diagram since the element identifier 107 “MyPackage” follows the UML element type classifier 106 “pkg.” Likewise, the UML element icon 115 is representative of an interface diagram since the element identifier 107 “Interface” follows the UML element type classifier 106 “inf.” The UML element type classifier 106 label and the element identifier 107 labels are manually entered into the UML element icon by the user via a conventional input device (e.g., a keyboard).

Within exemplary embodiments, the present modeling tool provides a way to generate UML models from the user defined conventions. In the event that a user enters a new convention for the first time within a UML element icon a “map-to” window will be displayed with a pull-down menu through which the user can enter an existing convention for a UML element type classifier 106 in order to dictate the operators that will be presented for the user to utilize in constructing the model. For example, for a “union” operator the user would probably select the UML element type classifier 106 “class,” for an “int” operator the user would select UML element type classifier 106 “type.” While generating the UML model, the tool would create profiles/stereotypes and type libraries that are based upon the user selected extensions.

Within further exemplary embodiments, in the instance that a UML element icon comprises a sub-compartment (120), UML concept type classifiers 108 and concept identifiers 109 can be listed within the UML element icon 120 in order to further define the utility features for the respective UML element icon 120. Concept identifiers are software convention specific type specifications, thus the concept identifier that is implemented depends upon the convention that the model to which the model is to be mapped is based. Thus, within UML element icon 120 since the concept identifier 109 “Attribute1” follows the UML concept type classifier 108 “att,” the concept identifier 109 “Attribute1” denotes an attribute of the UML element icon 120. Similarly, since the concept identifier 109 “Operation1( )” follows the UML concept type classifier 108 “ops,” the concept identifier 109 “Operation1( )” denotes an operation of the UML element icon 120.

Within further exemplary embodiments a user may type out an entire string of characters or be prompted by the GUI to enter a keyword from a drop-down list provided by the GUI. For example, consider the string:

ops:Operation1:return void:param Param1:int, Param2:Class2:exception Class4

where “void” represents the return type, “param Param1:int, Param2:Class2” constitutes the comma separated parameter list and Class4 would be the exception thrown. When a user enters a colon while typing a pull-down menu will automatically be activated that provides the user with a selection the appropriate keywords (e.g., for example “param” for Parameters, “throw” for Operations, etc.).

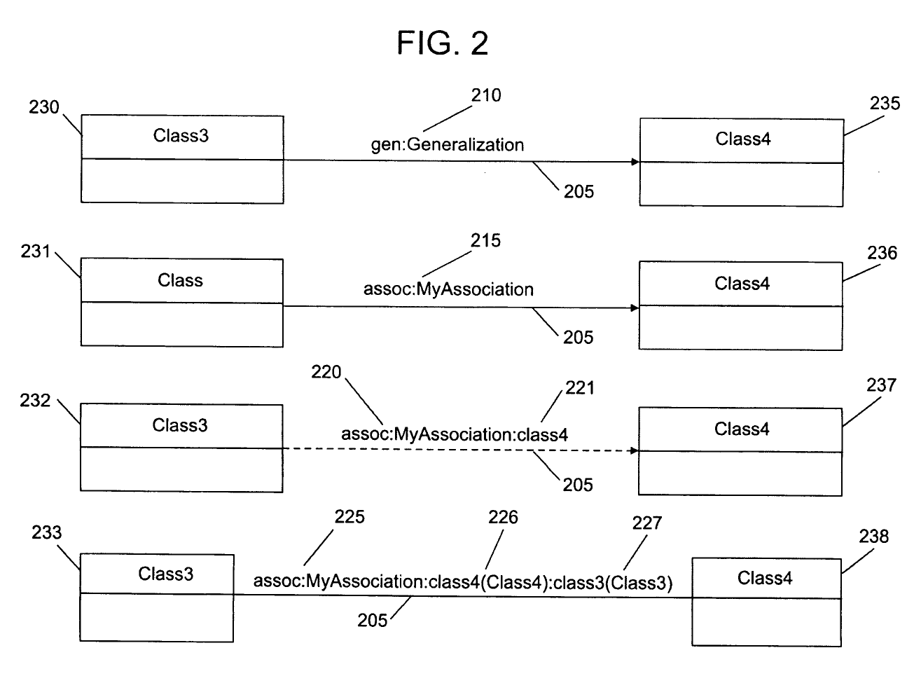

FIG. 2 shows a connector icon 205 that can be used to show that a relationship exists between two UML element icons 230-233 and 235-238. The relationships between UMI, element icons 230-233 and 235-238 can be expressed by displaying an arrow at the end of a connector 205 line segment that is visually in connection with a UML element icon 230-233 and 235-238. Further, the relationship between UML element icons 230-233 and 235-238 can be defined by the use of a qualifying relationship classifier (210, 215, 220, and 225). As such, the qualifying relationship classifier 210 denotes that the generalization of “class3” of UML element icon 230 from “class4” of UML element icon 235. Similarly, the qualifying relationship classifier 215 denotes the association between “class3” of UML element icon 231 and UML element icon 236. Thus, all relationships between UML element icons can be expressed with the use of a qualifying relationship classifier.

In the event that the relationship as expressed between UML element icons requires a role (e.g., such with the usage of qualifiers such as an association or a composition) the role name will follow the qualifying relationship classifier. For example, the qualifying relationship classifier 220 “assoc:MyAssociation” is followed by the role classification label 221 “class4.” Further a bidirectional relationships, there would be two role names will be implemented. As such, the user can specify the class name of the qualifying relation classifier next to the role name in order to specify which class plays what role. For example, the qualifying relationship classifier 225 “assoc:MyAssociation” implemented in conjunction with the role “class4(Class4)” 226 and “class3(Class3) 227.”

In some situations, for the ease of understanding a domain (e.g., within domain specific modeling), for platform specific designs (e.g., within platform specific modeling), etc., a users may need to extend the software specific conventions that are utilized to describe a model. Thus, within further exemplary embodiments it is possible to extend convention mappings to stereotyping in UML. For example, a C++ user may utilize a “union” operator while or a Java user may utilize a “struct’ operator in the course of design. Within exemplary embodiments, users will be able to map new keywords or operator conventions into existing ones (e.g., “union” or “struct” operators for example may be mapped to the class convention within the UML element icon, while “int” or “char” operators may be mapped on to the type convention within a UML element icon.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for creating a UML model, the method comprising:
displaying a GUI at a display device, wherein the GUI comprises a modeling interface window, the interface window further display an icon repository window, the icon repository window displaying an icon of a UML element and a UML connector comprising a first end and a second end;
creating a model by dragging at least two UML element icons from the icon repository window into the modeling interface window, each UML element icon further comprising a sub-compartment;
defining the utility of the at least two UML element icons by labeling each icon with a UML element type classifier and an UML element identifier;
defining the relationship between the at least two UML element icons by dragging a connector from the icon repository window into the modeling interface window and placing the first and second end of the connector in visual contact with differing UML element icons, wherein the utility of the connector is identified by labeling the connector with a qualifying relationship classifier and a role classification label;
defining at least one UML concept for a UML element icon by labeling the sub-compartment of a box with a UML concept classifier and a UML concept designator;
extending the definitions of the definition of the utility of a UML element icon or a UML concept classifier by appending a predetermined convention-based concept designator to the UML element icon or UML concept classifier label; and
generating a UML model based upon the model drawn within the modeling interface window.

2. The method of claim 1, further comprising a user extending the definitions of the definition of the utility of a UML element icon or a UML concept classifier by manually entering a predetermined convention-based concept designator.

3. The method of claim 2, further comprising a user extending the definitions of the definition of the utility of a UML element icon or a UML concept classifier by selecting the convention based designator from a pull-down menu displayed on the GUI.
